(19) United States
(12) Patent Application Publication
(10) Pub. No.: US 2026/0196498 A1
(43) Pub. Date: Jul. 9, 2026

(54) Systems and Methods For Rechargeable Energy Source Systems With De-Lithiated Positive Electrodes

(71) Applicant: Pure Lithium Corporation, Chicago, IL (US)

(72) Inventors: Emilie BODOIN, Boston, MA (US); Ayesha AKTER, Charlestown, MA (US); Kristin PERSSON, Chicago, IL (US); Gerbrand CEDER, Chicago, IL (US); Haoming LI, Chicago, IL (US); Qian CHEN, Chicago, IL (US)

(21) Appl. No.: 19/423,370

(22) Filed: Dec. 17, 2025

Related U.S. Application Data
(63) Continuation of application No. PCT/US2024/034848, filed on Jun. 20, 2024.
(60) Provisional application No. 63/509,109, filed on Jun. 20, 2023.

(51) Int. Cl. H01M 4/58; H01M 4/02; H01M 10/0525

(52) U.S. Cl. CPC H01M 4/582; H01M 10/0525; H01M 2004/021

(57) ABSTRACT

In some aspects, the present disclosure provides a rechargeable energy source system. The rechargeable energy source system can comprise a negative electrode comprising a layer of lithium metal having a density of at least about 0.4 g/cm³ and an impurity level of less than about 50 ppm by mass. The rechargeable energy source system can comprise a positive electrode that is synthesized to be substantially free of lithium. The positive electrode can have a capacity of at least 250 mAh/g and a gravimetric energy density of at least 800 Wh/kg.

### CROSS-REFERENCE

This application is continuation application of International Application No. PCT/US2024/034848, filed Jun. 20, 2024, which claims the benefit of U.S. Provisional Application No. 63/509,109, filed Jun. 20, 2023, each of which is incorporated herein by reference in its entirety.

### STATEMENT AS TO FEDERALLY SPONSORED RESEARCH

This present disclosure was made with government support under DE-AC02-05CH11231 awarded by the Department of Energy. The government has certain rights in the disclosure.

### BACKGROUND

Redox materials can be used in rechargeable energy source systems as a positive electrode.

### SUMMARY

In some aspects, the present disclosure provides an electrochemical system comprising: a negative electrode comprising a layer of lithium metal having a density of at least about 0.4 g/cm3; and a positive electrode that is substantially free of lithium when the rechargeable energy source system is in a charged state; wherein the positive electrode has a capacity of at least 300 mAh/g and a gravimetric energy density of at least 800 Wh/kg.

In some aspects, the present disclosure provides an electrochemical system comprising: a negative electrode comprising a layer of lithium metal having a density of at least about 0.4 g/cm3; and a positive electrode that is substantially free of lithium when the rechargeable energy source system is in a charged state; wherein the positive electrode has a capacity of at least 250 mAh/g, and wherein the positive electrode is configured to exhibit a volumetric change of less than about 15% between a discharged state and a charged state.

In some embodiments, the positive electrode is configured to maintain the volumetric change over at least 100 charge/discharge cycles of the electrochemical system.

In some embodiments, the positive electrode comprises vanadium atoms. In some embodiments, the positive electrode comprises VₓO_{y}. In some embodiments, the positive electrode comprises VₓO_{y}F_{z}. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)2, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈. In some embodiments, the positive electrode comprises FePO₄, NiMnCoO₂, or TiS₂.

In some embodiments, the rechargeable energy source system comprises lithium in excess, the lithium in excess comprising less than about 10% of a net amount of lithium transferred between the negative electrode and the positive electrode during discharging or charging of the rechargeable energy source system. In some embodiments, the positive electrode is configured to exhibit a volumetric change of less than about 10% over at least 100 charge/discharge cycles of the rechargeable energy source system. In some embodiments, an energy capacity loss of the rechargeable energy source system is less than about 1% over at least 100 charge/discharge cycles. In some embodiments, an energy capacity loss of the rechargeable energy source system is less than about 1% over at least 300 charge/discharge cycles. In some embodiments, a N/P ratio is less than 0.1 when the rechargeable energy source system is fully discharged. In some embodiments, a N/P ratio is about zero when the rechargeable energy source system is fully discharged.

In some embodiments, the lithium from the negative electrode is added into the positive electrode via an intercalation mechanism or a conversion mechanism.

In some embodiments, the layer of lithium metal comprises a thickness of less than 100 μm. In some embodiments, the positive electrode comprises less than 10% lithium by mass.

In some aspects, the present disclosure provides an electrochemical system in which at least 90% of total lithium undergoes oxidation to Li+ on discharge and reduction, with a potential difference of at least 2.5 Volts between a negative electrode and a positive electrode of the rechargeable energy source system, wherein discharging the rechargeable energy source system expands a volume of the positive electrode by less than 15%, and wherein the positive electrode has a capacity of at least 250 mAh/g.

In some aspects, the present disclosure provides an electrochemical system comprising: a negative electrode comprising a layer of lithium metal, wherein in a discharged state of the rechargeable energy source system, the negative electrode comprises less than 10% of total lithium in the rechargeable energy source system; and a positive electrode comprising VₓO_{y}, wherein in a charged state of the rechargeable energy source system, the positive electrode comprises less than 10% of total lithium in the rechargeable energy source system while being structurally stable; wherein a difference in volume of the positive electrode between the discharged state and the charged state of the rechargeable energy source system is less than 10%; wherein a potential difference, excluding overpotentials, between the negative electrode and the positive electrode is at least 2.5 V; and wherein the energy density of the rechargeable energy source system is at least 225 Wh/kg.

In some aspects, the present disclosure provides a rechargeable energy source system comprising an electrochemical system disclosed herein.

In some aspects, the present disclosure provides method of making an electrode, comprising: mixing one or more VₓO_{y}F_{z} precursors into a mixture; heating the mixture to at least 350° C. or at most 550° C. for at least 2 hours or at most 12 hours to produce a solid phase; coating the solid phase with carbon; mixing the solid phase with a binder; and casting the solid phase onto a current collector.

In some embodiments, the one or more VₓO_{y}F_{z} precursors comprise VᵢFⱼ, VₖOₗ, or both. In some embodiments, the one or more VₓO_{y}F_{z} precursors comprise VF₄, V₂O₅, or both.

In some embodiments, the method further comprises calendaring the solid phase on the current collector. In some embodiments, the solid phase comprises a powder.

In some aspects, the present disclosure provides a rechargeable energy source system comprising: a negative electrode comprising a layer of lithium metal having a density of at least about 0.4 g/cm³ and an impurity level of less than about 50 ppm by mass; and a positive electrode that is substantially free of lithium when the rechargeable energy source system is in a charged state; wherein the positive electrode has a capacity of at least 250 mAh/g and a gravimetric energy density of at least 800 Wh/kg.

In some embodiments, the positive electrode comprises vanadium atoms. In some embodiments, the positive electrode comprises VₓO_{y}. In some embodiments, the positive electrode comprises VₓO_{y}F_{z}. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈. In some embodiments, the positive electrode comprises FePO₄, NiMnCoO₂, or TiS₂.

In some embodiments, the rechargeable energy source system comprises lithium in excess, the lithium in excess comprising less than about 10% of a net amount of lithium transferred between the negative electrode and the positive electrode during discharging or charging of the rechargeable energy source system. In some embodiments, the positive electrode is configured to exhibit a volumetric change of less than about 10% over at least 100 charge/discharge cycles of the rechargeable energy source system. In some embodiments, an energy capacity loss of the rechargeable energy source system is less than about 1% over at least 100 charge/discharge cycles. In some embodiments, a N/P ratio is less than 0.1 when the rechargeable energy source system is fully discharged. In some embodiments, a N/P ratio is about zero when the rechargeable energy source system is fully discharged. In some embodiments, the lithium from the negative electrode is added into the positive electrode via an intercalation mechanism or a conversion mechanism. In some embodiments, the layer of lithium metal comprises a thickness of less than 100 μm. In some embodiments, the positive electrode comprises less than 10% lithium by mass.

In some aspects, the present disclosure provides a rechargeable energy source system that carries out a redox reaction for at least 90% of total lithium in the rechargeable energy source system while charging and while discharging, with a potential difference of at least 2.5 Volts between a negative electrode and a positive electrode of the rechargeable energy source system, wherein discharging the rechargeable energy source system expands a volume of the positive electrode by less than 15%.

In some aspects, the present disclosure provides a rechargeable energy source system comprising: a negative electrode comprising a layer of lithium metal, wherein in a discharged state of the rechargeable energy source system, the negative electrode comprises less than 10% of total lithium in the rechargeable energy source system; and a positive electrode comprising VₓO_{y}, wherein in a charged state of the rechargeable energy source system, the positive electrode comprises less than 10% of total lithium in the rechargeable energy source system while being structurally stable; wherein a difference in volume of the positive electrode between the discharged state and the charged state of the rechargeable energy source system is less than 10%; wherein a potential difference, excluding overpotentials, between the negative electrode and the positive electrode is at least 2.5 V; and wherein the energy density of the rechargeable energy source system is at least 350 Wh/kg.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A shows a rechargeable energy source at a charged state, the arrow indicating the direction of lithium transport while discharging, in accordance with some embodiments.

FIG. 1B shows a rechargeable energy source at a discharged state, the arrow indicating the direction of lithium transport while charging, in accordance with some embodiments.

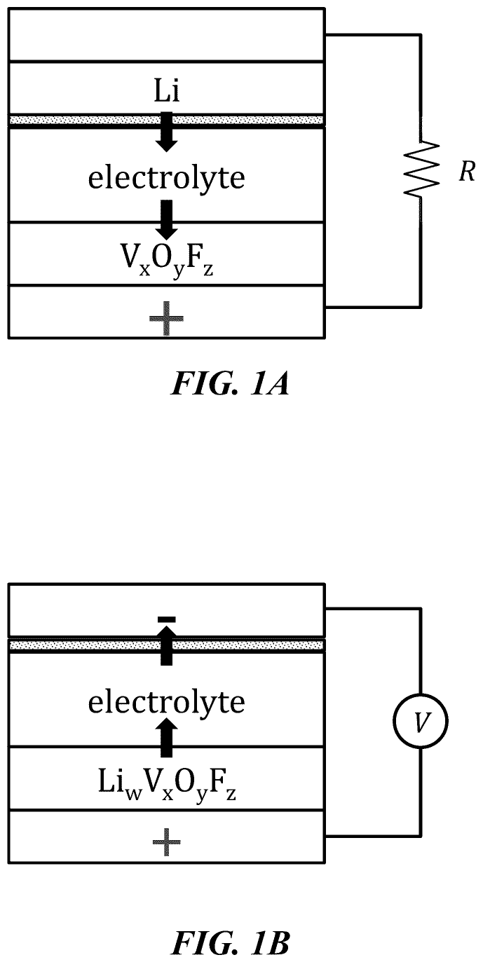

### DETAILED DESCRIPTION

In some aspects, the present disclosure provides a rechargeable energy source system. In some embodiments, rechargeable energy source system comprises a negative electrode. In some embodiments, rechargeable energy source system comprises a positive electrode.

As used herein, “cathode” can refer to an electrode where a reduction half-reaction occurs. As used herein, “anode” can refer to an electrode where an oxidation half-reaction occurs. As used herein, “redox reaction” can refer to the sum of the two half-reactions. As used herein, “negative electrode” can refer to an electrode comprising lithium metal. As used herein, “positive electrode” can refer to an electrode comprising a redox material.

In some embodiments, a rechargeable energy storage system uses a redox reaction where charge carriers are transferred between materials in an electrochemical process. In some embodiments, charge carriers can be electrons or ions. The redox reaction can occur reversibly.

As used herein, “galvanic cell” can refer to a forward or discharge reaction which outputs energy. As used herein, “electrolytic cell” can refer to a reverse or charge reaction that consumes energy. In some embodiments, upon charge, one electrode experiences an oxidation half-reaction. In some embodiments, upon discharge, the electrode undergoes a reduction half-reaction.

As used herein, “lithiation,” “forward reaction,” or “discharge reaction” can refer to the migration of lithium ions towards the negative electrode. In some embodiments, lithiation functions by an intercalation mechanism, a conversion mechanism, or both. As used herein “intercalation mechanism” can refer to a mechanism where lithium ions occupy the pores of a scaffolding material. As used herein a “conversion mechanism” can refer to a mechanism where lithium ions burrow into metallic vacancies in an electrode. Conversion mechanism may involve a diffusion-based conversion, alloying-based conversion, or both.

In some aspects, the present disclosure provides an electrochemical system. In some embodiments, the electrochemical system comprises a negative electrode. In some embodiments, the electrochemical system comprises a positive electrode.

In the design of rechargeable energy source systems, the selection of the positive electrode material provides some factors for consideration. A positive electrode material may be able to provide better energy density if (i) the number of itinerant ions (Li+, in a lithium battery) that the positive electrode material can hold and release is large, and/or (ii) the potential difference between the positive electrode material and the negative electrode material is large. Without being bound to a particular theory, one may calculate the theoretical energy density of some rechargeable energy source systems as the product of (i) the number of itinerant ions (Li+ in this system) that participate in faradaic (charge transfer) reactions at the electrodes and (ii) the electrochemical potential associated with the faradaic reactions. Another factor for consideration is the change in specific volume in the positive electrode between the charged state and the discharged state of the rechargeable energy source system. Smaller changes in the specific volume may confer better structural stability to the positive electrode.

The positive electrode material can have atoms that are capable of interconverting between two valence states. For example, the present disclosure provides certain embodiments of positive electrode materials that comprise vanadium atoms and are synthesized to be substantially free of lithium. One such material is V₆O₅F₁₉ which, when saturated with lithium, can comprise a chemical formula of Li₅V₆O₅F₁₉. When a positive electrode material interconverts between those two valence states during charge and discharge of a rechargeable energy source system, the material is theoretically able to utilize all of the lithium it receives. Higher utilization can provide reduced excess lithium. Reduced excess lithium can reduce the amount of lithium used in a rechargeable energy source system, decreasing costs and footprint. For example, the interconversion between V₆O₅F₁₉+5 Li⁺↔Li₅V₆O₅F₁₉ can be associated with changes in the oxidation states of vanadium atoms in the material to provide a larger electrochemical potential for reactions. Vanadium is an element capable of multiple oxidation states, e.g., +2, +3, +4, and +5. This reaction, can raise the theoretical potential of the faradaic reactions, thereby raising the amount of energy released (or stored) per lithium atom. In some embodiments, the lithium can be added into the positive electrode material via a conversion mechanism. In some embodiments, the lithium can also be added into the positive electrode via an intercalation mechanism.

Chemical and physical stability of the positive electrode material can improve the safety of rechargeable energy source systems, and reduce the loss of capacity or energy density over time. Large volume changes in the positive electrode material can be associated with instability (although not always). In the instance of V₆O₅F₁₉+5 Li⁺↔Li₅V₆O₅F₁₉, a theoretically expected volume change is 3%. It can be expected that lower volume change provides better stability of the positive electrode material by reducing the development of new cracks and reducing the propagation of existing cracks.

In some aspects, the present disclosure provides an electrochemical system. In some embodiments, the electrochemical system comprises a negative electrode comprising a layer of lithium metal having a density of at least about 0.4 g/cm³. In some embodiments, the electrochemical system comprises a positive electrode that is substantially free of lithium when the rechargeable energy source system is in a charged state. In some embodiments, the positive electrode has a capacity of at least 300 mAh/g. In some embodiments, the positive electrode has a capacity of at least 250 mAh/g. In some embodiments, the positive electrode has a gravimetric energy density of at least 800 Wh/kg. In some embodiments, the positive electrode is configured to exhibit a volumetric change of less than about 15% between a discharged state and a charged state. In some embodiments, the positive electrode is configured to maintain the volumetric change over at least 100 charge/discharge cycles of the electrochemical system.

In some embodiments, the lithium from the negative electrode is added into the positive electrode via an intercalation mechanism or a conversion mechanism. In some embodiments, the positive electrode comprises vanadium atoms. In some embodiments, the positive electrode comprises VₓO_{y}. In some embodiments, the positive electrode comprises VₓO_{y}F_{z}. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)2, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈. In some embodiments, the positive electrode comprises FePO₄, NiMnCoO₂, or TiS₂.

In some embodiments, the rechargeable energy source system comprises lithium in excess, the lithium in excess comprising less than about 10% of a net amount of lithium transferred between the negative electrode and the positive electrode during discharging or charging of the rechargeable energy source system. In some embodiments, the positive electrode is configured to exhibit a volumetric change of less than about 10% over at least 100 charge/discharge cycles of the rechargeable energy source system. In some embodiments, an energy capacity loss of the rechargeable energy source system is less than about 1% over at least 100 charge/discharge cycles. In some embodiments, an energy capacity loss of the rechargeable energy source system is less than about 1% over at least 300 charge/discharge cycles. In some embodiments, a N/P ratio is less than 0.1 when the rechargeable energy source system is fully discharged. In some embodiments, a N/P ratio is about zero when the rechargeable energy source system is fully discharged.

In some embodiments, the layer of lithium metal comprises a thickness of less than 100 μm. In some embodiments, the positive electrode comprises less than 10% lithium by mass.

In some aspects, the present disclosure provides an electrochemical system in which at least 90% of total lithium undergoes oxidation to Li+ on discharge and reduction, with a potential difference of at least 2.5 Volts between a negative electrode and a positive electrode of the rechargeable energy source system, wherein discharging the rechargeable energy source system expands a volume of the positive electrode by less than 15%, and wherein the positive electrode has a capacity of at least 250 mAh/g.

In some aspects, the present disclosure provides an electrochemical system comprising: a negative electrode comprising a layer of lithium metal, wherein in a discharged state of the rechargeable energy source system, the negative electrode comprises less than 10% of total lithium in the rechargeable energy source system; and a positive electrode comprising VₓO_{y}, wherein in a charged state of the rechargeable energy source system, the positive electrode comprises less than 10% of total lithium in the rechargeable energy source system while being structurally stable; wherein a difference in volume of the positive electrode between the discharged state and the charged state of the rechargeable energy source system is less than 10%; wherein a potential difference, excluding overpotentials, between the negative electrode and the positive electrode is at least 2.5 V; and wherein the energy density of the rechargeable energy source system is at least 225 Wh/kg.

In some aspects, the present disclosure provides a rechargeable energy source system comprising an electrochemical system disclosed herein.

In some aspects, the present disclosure provides method of making an electrode. In some embodiments, the method comprises mixing one or more VₓO_{y}F_{z} precursors into a mixture. In some embodiments, the method comprises heating the mixture to at least 350° C. or at most 550° C. for at least 2 hours or at most 12 hours to produce a solid phase. In some embodiments, the method comprises heating the mixture to at least 375, 400, 425, 450, 475, 500, 525, or 525° C. In some embodiments, the method comprises heating the mixture to at most 375, 400, 425, 450, 475, 500, 525, or 525° C. In some embodiments, the method comprises heating the mixture for at least 2, 3, 4, 5, 6, 7, 8, 9, 10, 11, or 12 hours. In some embodiments, the method comprises heating the mixture for at most 2, 3, 4, 5, 6, 7, 8, 9, 10, 11, or 12 hours. In some embodiments, the method comprises coating the solid phase with a conductive material. In some embodiments, the conductive material comprises carbon. In some embodiments, the method comprises mixing the solid phase with a binder. In some embodiments, the binder comprises a polymer. In some embodiments, the polymer comprises polyvinylidene fluoride. In some embodiments, the method comprises casting the solid phase onto a current collector. In some embodiments, the one or more VₓOF_{z} precursors comprise VᵢFⱼ, VₖOₗ, or both. In some embodiments, the one or more VₓO_{y}F_{z} precursors comprise VF₄, V₂O₅, or both. In some embodiments, the method further comprises calendaring the solid phase on the current collector. In some embodiments, the solid phase comprises a powder.

### Positive Electrode

In some aspects, the present disclosure provides a positive electrode. The positive electrode can comprise a redox material. The redox material can be synthesized to be substantially free of lithium. The redox material can be in contact with a substrate.

The redox material can comprise a lithium intercalating material. The redox material can comprise a multi-electron intercalating material. The redox material can comprise a transition metal, which undergoes a change in oxidation state of at least two between a charged and discharged state. The redox material can be configured to receive lithium via an intercalation mechanism, a conversion mechanism, or both.

Provided herein are various redox materials. The redox material can be integrated into a rechargeable energy source system. Table 1 provides a list of some redox materials for the positive electrode, in accordance with some embodiments (Volts: V; milliampere-hours: mAh; gram: g; wait-hours: Wh; kilograms: kg).

TABLE 1
Some material choices for the redox materials of the positive electrode.

| | | | | | Volume |
|---|---|---|---|---|---|
| | | | | | Change |
| | Chemical | | | | between |
| Chemical | Formula | | | | Charged |
| Formula in a | in a | Average | | Energy | State and |
| Charged | Discharged | Voltage | Capacity | Density | Discharged |
| State | State | (V) | (mAh/g) | (Wh/kg) | State |
| V₆O₅F₁₉ | Li₁₁V₆O₅F₁₉ | 3.7 | 358.24 | 1326.04 | 0.03 |
| V₃OF₁₁ | Li₄V₃OF₁₁ | 3.78 | 264.33 | 999.54 | 0.11 |
| VO₂F | LiVO₂F | 3.68 | 246.16 | 906.4 | 0 |
| VOF₃ | LiVOF₃ | 4.1 | 204.78 | 839.22 | 0.05 |
| VPO₄F | Li₂VPO₄F | 2.81 | 299.8 | 841.6 | 0.15 |
| LiV₃OF₁₁ | Li₄V₃OF₁₁ | 4.05 | 198.25 | 803.4 | 0.03 |
| Mn₃V(PO₄)₆ | Li₆Mn₃V(PO₄)₆ | 3.96 | 194.39 | 770.77 | 0.05 |
| V₆O₅F₁₉ | Li₅V₆O₅F₁₉ | 4.25 | 171.51 | 728.68 | 0.07 |
| V₂(PO₄)₃ | Li₃V₂(PO₄)₃ | 3.38 | 197.25 | 667.23 | 0.06 |
| LiVOF₄ | Li₂VOF₄ | 4.15 | 170.91 | 709.09 | 0.06 |
| LiV(OF)₂ | Li₂V(OF)₂ | 3.74 | 198.8 | 744.23 | 0.02 |
| LiV(OF)₂ | Li₂V(OF)₂ | 3.24 | 198.8 | 644.82 | 0.05 |
| MnVP₂(O₄F)₂ | Li₂MnVP₂(O₄F)₂ | 4.23 | 154.16 | 652.3 | 0.04 |
| V₄O₇F₅ | Li₃V₄O₇F₅ | 3.44 | 186.3 | 640.52 | 0.02 |
| LiV₃CoO₁₀ | Li₄V₃CoO₁₀ | 3.52 | 201.25 | 709.28 | 0.02 |
| VPO₅ | LiVPO₅ | 3.83 | 158.73 | 608.25 | 0.01 |
| VFeP₂(O₄F)₂ | Li₂VFeP₂(O₄F)₂ | 4.14 | 153.76 | 635.86 | 0.04 |
| TiVO₄ | Li₂TiVO₄ | 2.09 | 303.38 | 633.01 | 0.06 |
| LiTiV₃O₁₀ | Li₄TiV₃O₁₀ | 3.09 | 206.99 | 640.22 | 0.01 |
| VFeP₂(HO₅)₂ | Li₂VFeP₂(HO₅)₂ | 4.07 | 155.54 | 632.36 | 0.02 |
| Li₂VOF₅ | Li₃VOF₅ | 4.11 | 146.65 | 602.68 | 0.01 |
| MnV₄O₁₂ | Li₃MnV₄O₁₂ | 3.66 | 170.52 | 624.68 | 0.08 |
| VBO₄ | LiVBO₄ | 2.79 | 201.98 | 564.52 | 0.13 |
| LiV₂P₂(O₄F)₂ | Li₂VPO₄F | 2.52 | 224.85 | 567.71 | 0.06 |
| LiV₃CrO₈ | Li₄V₃CrO₈ | 2.83 | 222.99 | 631.23 | 0.01 |
| V₄(OF₃)₃ | Li₃V₄(OF₃)₃ | 2.96 | 181.27 | 535.66 | 0.01 |
| LiV₄O₈ | LiVO₂ | 2.73 | 223.64 | 611.49 | 0.02 |
| V(CO₃)₂ | LiV(CO₃)₂ | 4.03 | 150.65 | 607.76 | 0.18 |
| LiV₅O₁₀ | LiVO₂ | 2.55 | 238.55 | 608.7 | 0.01 |
| VCuO₄ | LiVCuO₄ | 3.86 | 144.54 | 557.67 | 0.06 |
| VCo₃O₈ | Li₂VCo₃O₈ | 4.19 | 145.02 | 607.14 | 0.05 |

The redox material can comprise atoms with multiple oxidation states. The redox material can comprise atoms of titanium, vanadium, chromium, manganese, iron, cobalt, copper, germanium, arsenic, niobium, molybdenum, technetium, ruthenium, rhodium, palladium, tin, antimony, or any combination thereof. The redox material can comprise vanadium atoms.

The redox material can comprise a transition metal. The redox material can comprise at least one of vanadium, cobalt, nickel, a cobalt-aluminum alloy, manganese, niobium, molybdenum, technetium, tungsten, rhenium, rhodium, ruthenium, iridium, palladium, or platinum atoms. The redox material can comprise vanadium atoms. The redox material can comprise an oxide. The redox material can comprise VₓO_{y} The redox material can comprise VₓO_{y}F, ‘X’, ‘Y’, and ‘Z’ may be integers. ‘X’, ‘Y’, and ‘Z’ may be real numbers, which can represent variations from exact stoichiometric ratios. The redox material can comprise at least one of V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, VCo₃O₈, or any combination thereof. The redox material can comprise FePO₄, NiMnCoO₂, or TiS₂.

The redox material can comprise a metal sulfide. The redox material can comprise titanium disulfide. The redox material can comprise a metal oxide. The positive electrode can comprise LiₓMO₂, wherein M is a metal. The redox material can comprise vanadium atoms. The redox material can comprise vanadium, cobalt, nickel, a cobalt-aluminum alloy, manganese, niobium, molybdenum, technetium, tungsten, rhenium, rhodium, ruthenium, iridium, palladium, platinum atoms, or any combination thereof. The redox material can comprise a polyatomic anion. The polyatomic anion can comprise PO₄.

The redox material can comprise additives. The redox material can comprise phosphate based materials such as FePO₄, VPO₄F, V₂(PO₄)₂F₃, FePO₄F, and V₂(PO₄)₃; oxides such as CoO₂, V₂O₅, orthorhombic MnO₂, layered iron oxides FeO₂, chromium oxide CrO₂, layered Ni_{0.5}Mn_{0.5}O₂, and V₆O₁₅ nanorods; layer sulfides such as TiS₂; perovskite transition metal fluorides, or a mixture thereof. The redox material can comprise a filler, which can be conductive, e.g., graphene. The redox material can comprise a binder, which can be a polymer, e.g., poly vinylidene fluoride.

The redox material can comprise less than 20, 15, 10, 9, 8, 7, 6, 5, 4, 3, 2, or 1 percent lithium by mass. The redox material can comprise greater than 20, 15, 10, 9, 8, 7, 6, 5, 4, 3, 2, or 1 percent lithium by mass. For example, the redox material can comprise less than 10% lithium by mass. The amount of lithium can be measured at a delithiated state.

In some embodiments, a positive electrode may be selected based on factors including, not limited to a high conductivity (both ionic and electronic), a low toxicity, a high crustal abundance, a low oxygen evolution, an upper voltage limit less than 4.5, and a low voltage cutoff higher than 50% of the upper cutoff window.

In some embodiments, a positive electrode comprises a capacity of at least 275, 280, 290, 300, or 305 mAh/g. In some embodiments, a positive electrode comprises a capacity of at most 275, 280, 290, 300, or 305 mAh/g.

### Structure

The redox material can comprise various forms. For example, the redox material can comprise sheets, ribbons, or particles. The redox material can comprise microstructures. The redox material can comprise nanostructures. The microstructures or the nanostructures can comprise substantially spherical, cylinder, or lamellar morphologies, or any combination thereof. Such structures may be deposited on a substrate surface.

### Additives

The redox material can comprise a binder. The binder can bind the redox material to the current collector. The binder can be electrically conductive. The binder can comprise polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (“SBR”), acrylated SBR, epoxy resin, and nylon. The binder can comprise carbon black or vapor ground carbon fibers. The binder can be polyvinylidene fluoride (PVDF), sodium alginate, and sodium carboxymethyl cellulose. The binder can comprise PVDF, polytetrafluoroethylene (PTFE), styrene butadiene rubber (SBR), and polyimide. The binder can graphene or carbon nanotubes.

The redox material can comprise a surface coating. The surface coating can comprise an oxide, a hydroxide, an oxyhydroxide, an oxycarbonate, or a hydroxycarbonate. The surface coating can be amorphous or crystalline. The surface coating can comprise magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr) atoms, or any combination thereof. The surface coating can be formed using a spray coating method, a dipping method, or any other suitable method.

The redox material can comprise a polymer binder. The polymer binder can comprise a block copolymer. The block copolymer can provide a hydrophobic domain on a surface of the electrode. A hydrophobic polymer membrane can be bound to the hydrophobic domain on the surface of the redox material.

### Substrate

The substrate can comprise a current collector. The current collector can comprise copper, stainless steel, aluminum, nickel, titanium, sintered carbon, copper or stainless steel that is surface-treated with carbon, nickel, titanium or silver, and aluminum-cadmium alloys. The current collector can comprise various forms including films, sheets, foils, nets, porous structures, foams, and non-woven fabrics. The current collector can comprise carbon, carbon paper, carbon cloth or a metal or noble metal mesh or foil. The current collector can comprise fine irregularities on surfaces thereof so as to enhance the adhesive strength of the current collector to the redox material. The current collector can have a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. The current collector can have a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm.

### Properties

The positive electrode can be configured to have a stable capacity. Over numerous cycles, the positive electrode can resist loss of redox material. For example, uncontrolled crack formation and propagation can lead to loss of redox material when a piece of the redox material comprising lithium breaks loose. The broken piece may become electrically isolated from the rest of the positive electrode, and the lithium contained within may not be able to participate in the redox reactions and not be able to contribute to the capacity and the energy density of the electrochemical system. Stable volume of the redox material with respect to its state of charge, temperature, and pressure may reflect the physical stability of the positive electrode.

The capacity of the positive electrode can be at least 50, 100, 150, 200, 250, 300, 350, 400, 450, or 500 mAh/g. The capacity of the positive electrode can be at most 50, 100, 150, 200, 250, 300, 350, 400, 450, or 500 mAh/g. For example, the capacity of the positive electrode can be at least 250 mAh/g. The energy density of the positive electrode can be at least 200, 400, 600, 800, 1000, 1200, 1400, or 1600 Wh/kg. The energy density of the positive electrode can be at most 200, 400, 600, 800, 1000, 1200, 1400, or 1600 Wh/kg. For example, the energy density of the positive electrode can be at least 800 Wh/kg.

In some embodiments, the redox material exhibits a volumetric change of less than about 50%, 45%, 40%, 35%, 30%, 25%, 20%, 15%, 10%, %, 4%, 3%, 2%, or 1% when cycled for a predetermined number of times. In some embodiments, the redox material exhibits a volumetric change of more than about 50%, 45%, 40%, 35%, 30%, 25%, 20%, 15, 1%, 5%, 4%, 3%, 2%, or 1% when cycled for a predetermined number of times. The predetermined number of times can be at least 50, 100, 150, 200, 250, 300, 350, 400, 500, 600, 700, 800, 900, 1000, 2000, 3000, 4000, or 5000 times. The predetermined number of times can be at most 50, 100, 150, 200, 250, 300, 350, 400, 500, 600, 700, 800, 900, 1000, 2000, 3000, 4000, or 5000 times. The cycling can be between 2 V and 4.5 V, 3 V and 4.5 V, or 2 V and 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C.

In some embodiments, an energy capacity loss of the positive electrode can be less than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over a predetermined number of cycles. The energy capacity loss of the positive electrode can be greater than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over a predetermined number of cycles. The predetermined number of times can be at least 50, 100, 150, 200, 250, 300, 350, 400, 500, 600, 700, 800, 1000, or 5000 times. The predetermined number of times can be at most 50, 100, 150, 200, 250, 300, 350, 400, 500, 600, 700, 800, 1000, or 5000 times. The cycling can be between 2 V and 4.5 V, 3 V and 4.5 V, or 2 V and 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C.

In some embodiments, a positive electrode comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9 percent over a predetermined number of cycles. In some embodiments, a positive electrode comprises a coulombic efficiency of at most 90, 91, 92, 93, 94, 95, 96, 97, 98, 99, 99.1, 99.2, 99.3, 99.4, 99.5, 99.6, 99.7, 99.8, or 99.9 percent over a predetermined number of cycles. The predetermined number of times can be at least 50, 100, 150, 200, 250, 300, 350, 400, 500, 600, 700, 800, 1000, or 5000 times. The predetermined number of times can be at most 50, 100, 150, 200, 250, 300, 350, 400, 500, 600, 700, 800, 1000, or 5000 times. The cycling can be between 2 V and 4.5 V, 3 V and 4.5 V, or 2 V and 3 V. The cycling can be performed at a C rate of at least C/20:C/20, C/10:C/10, C/5:C/5, C/2:C/2, 1C: 1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C.

In some embodiments, the positive electrode has a capacity of at least 250 mAh/g. In some embodiments, the positive electrode has a capacity of at least 100, 150, 200, 250, 300, or 350 mAh/g. In some embodiments, the positive electrode has a capacity of at most 500 mAh/g. In some embodiments, the positive electrode has a capacity of at most 450, 400, 350, 300, 250, 200, or 150 mAh/g.

In some embodiments, the positive electrode has a gravimetric energy density of at least 800 Wh/kg. In some embodiments, the positive electrode has a gravimetric energy density of at least 400, 450, 500, 550, 600, 650, 700, 750, 800, 850, 900, 950, 1000, 1050, 1100, 1150, 1200, 1250, or 1300 Wh/kg. In some embodiments, the positive electrode has a gravimetric energy density of at most 1500 Wh/kg. In some embodiments, the positive electrode has a gravimetric energy density of at most 450, 500, 550, 600, 650, 700, 750, 800, 850, 900, 950, 1000, 1050, 1100, 1150, 1200, 1250, 1300, 1350, 1400, or 1450 Wh/kg.

In some embodiments, the positive electrode comprises an atoms with multiple oxidation states. In some embodiments, the positive electrode comprises titanium, vanadium, chromium, manganese, iron, cobalt, copper, germanium, arsenic, niobium, molybdenum, technetium, ruthenium, rhodium, palladium, tin, antimony atoms, or any combination thereof. In some embodiments, the positive electrode comprises vanadium atoms.

In some embodiments, the positive electrode comprises an oxide. In some embodiments, the positive electrode comprises VₓO_{y}. In some embodiments, the positive electrode comprises VₓO_{y}F_{z}. ‘X’, ‘Y’, and ‘Z’ may be integers. ‘X’, ‘Y’, and ‘Z’ may be real numbers, which can represent variations from exact stoichiometric ratios. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈. In some embodiments, the positive electrode comprises FePO₄, NiMnCoO₂, or TiS₂.

The rechargeable energy source system can comprise a negative electrode. The negative electrode can comprise lithium metal. The lithium metal can be comprised in a layer. The layer of lithium metal can be substantially pure or dense. For example, the layer of lithium metal can comprise density of at least 0.4 g/cm³. In some embodiments, the layer of lithium metal can comprise density of at least 0.41, 0.42, 0.43 0.44, 0.45, 0.46, 0.47, 0.48, 0.49, 0.50, 0.51, or 0.52 g/cm³. In some cases, the layer of lithium metal can comprise density of at most 0.41, 0.42, 0.43 0.44, 0.45, 0.46, 0.47, 0.48, 0.49, 0.50, 0.51, 0.52, or 0.53 g/cm³. The density can be determined, e.g., at room temperature. In some embodiments, the layer of lithium metal can comprise less than 50 ppm of an impurity. The layer of lithium metal can comprise less than 45, 40, 35, 30, 25, 20, 15, 10, or 5 ppm of an impurity. The layer of lithium metal can comprise greater than 0, 5, 10, 15, 20, 25, 30, 35, 40, or 45 ppm of an impunity. The impurity can be determined by mass or moles. The impurity can be a metallic impurity.

The rechargeable energy source system can be an “anodeless” system. As used herein, an “anodeless” system can refer to a rechargeable energy storage system comprising, at a fully discharged state, an anode-free state but with a current collector. An “anodeless” system may comprise a trace of an anode material (e.g., small portion of remaining lithium, which could be identified with a surface interrogation technique) but comprise a current collector, when at a fully discharged state.

In some embodiments, an anodic reaction of an anodeless system occurs within the electrolyte rather than on or in a substrate. For example, in a wet-state “anode-free” lithium metal battery system, the negative electrode comprises metallic lithium, and the positive electrode is functionally within the electrolyte. The potential of the positive electrode reaction can be collected by an electrochemically inactive metal current collector. The electrolyte can serve both as the electrolyte and the site of the positive electrode reaction. The electrolyte and positive electrode can be referred to as “phase-unified,” or “mutually solvated.”

A N/P ratio can be a measure of a capacity ratio between the negative electrode and the positive electrode in the rechargeable energy system. In some embodiments, the rechargeable energy source system comprises a N/P ratio of less than 0.1 when the rechargeable energy source system is fully discharged. In some embodiments, the rechargeable energy source system comprises a N/P ratio of less than 0.2, 0.15, 0.1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 1e⁻³, 1e⁻⁴, 1e⁻⁵, or 1e⁻⁶ when the rechargeable energy source system is fully discharged. In some embodiments, the rechargeable energy source system comprises a N/P ratio of greater than 0.15, 0.1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 1e⁻³, 1e⁻⁴, 1e⁻⁵, or 1e⁻⁶ when the rechargeable energy source system is fully discharged. In some embodiments, the rechargeable energy source system comprises a N/P ratio of about zero when the rechargeable energy source system is fully discharged. In some embodiments, the positive electrode comprises less than 10% lithium in the rechargeable energy source system by mass. In some embodiments, the positive electrode comprises less than 20%, 15%, 10%, 9%, 8%, 7%, 6%, 5%, 4%, 3%, 2%1, %, 0.9%, 0.8%, 0.7%, 0.6%, 0.5%, 0.4%, 0.3%, 0.2%, or 0.1% lithium in the rechargeable energy source system by mass when charged. In some embodiments, the positive electrode comprises greater than 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or 0% lithium in the rechargeable energy source system by mass when charged. When charged, the negative electrode can comprise a layer of lithium metal comprising a thickness of less than 100 μm. When charged, the negative electrode can comprise a layer of lithium metal comprising a thickness of less than 500, 400, 300, 200, 100, 90, 80, 70, 60, 50, 40, 30, 20, or 10 μm. When charged, the negative electrode can comprise a layer of lithium metal comprising a thickness of greater than 0, 10, 20, 30, 40, 50, 60, 70, 80, 90, 100, 200, 300, or 400 μm.

The rechargeable energy source system can comprise some or no lithium in excess. The lithium in excess can be a fraction of a net amount of lithium transferred between the negative electrode and the positive electrode during discharging or charging of the rechargeable energy source system. The lithium in excess can be a fraction of a net amount of lithium transferred between the two opposing electrodes during discharging or charging of the rechargeable energy source system. The lithium in excess can be less than 20%, 15%, 10%, 9%, 8%, 7%, 6%, 5%, 4%, 3%, 2%, or 1%. The lithium in excess can be more than 20%, 15%, 10%, 9%, 8%, 7%, 6%, 5%, 4%, 3%, 2%, or 1%.

The positive electrode can be configured to have a stable capacity. Over numerous cycles, the positive electrode can resist loss of active material. For example, uncontrolled crack formation and propagation can lead to loss of active material when a piece of the positive electrode comprising lithium breaks loose. The broken piece may become electrically isolated from the rest of the positive electrode, and the lithium contained within may not be able to participate in the redox reactions that contribute to the capacity and the energy density of the electrochemical system. Stable volume of the positive electrode may reflect the physical stability of the positive electrode. In some embodiments, the positive electrode can be configured to exhibit a volumetric change of less than about 10% over at least 100 charge/discharge cycles of the rechargeable energy source system. In some embodiments, the positive electrode can be configured to exhibit a volumetric change of less than 30%, 25%, 20%, 15%, 10%, 5%, 4%, 3%, 2%, or 1% over at least 100 charge/discharge cycles of the rechargeable energy source system. In some embodiments, the positive electrode can be configured to exhibit a volumetric change of at least 0% over at least 100 charge/discharge cycles of the rechargeable energy source system. In some embodiments, the positive electrode can be configured to exhibit a volumetric change of greater than 1%, 2%, 3%, 4%, 5%, 10%, 15%, 20%, or 25% over at least 100 charge/discharge cycles of the rechargeable energy source system. In some embodiments, the positive electrode can be configured to exhibit a volumetric change of less than about 20% over at least 1000 charge/discharge cycles of the rechargeable energy source system. In some embodiments, the positive electrode can be configured to exhibit a volumetric change of less than about 50%, 45%, 40%, 35%, 30%, 25%, 20%, 15%, 10%, or 5% over at least 1000 charge/discharge cycles of the rechargeable energy source system. In some embodiments, the positive electrode can be configured to exhibit a volumetric change of greater than about 0%, 5%, 10%, 15%, 20%, 25%, 30%, 35%, 40%, or 45% over at least 1000 charge/discharge cycles of the rechargeable energy source system. In some embodiments, an energy capacity loss of the rechargeable energy source system can be less than about 1% over at least 100 charge/discharge cycles. In some embodiments, an energy capacity loss of the rechargeable energy source system can be less than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over at least 100 charge/discharge cycles. In some embodiments, an energy capacity loss of the rechargeable energy source system can be greater than about 0.01% over at least 100 charge/discharge cycles. In some embodiments, an energy capacity loss of the rechargeable energy source system can be greater than about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 10%, 15%, 20%, or 25% over at least 100 charge/discharge cycles.

### Electrolyte

In some embodiments, an electrolyte comprises an aqueous electrolyte. In some embodiments, an electrolyte comprises a non-aqueous electrolyte. In some embodiments, an electrolyte comprises a polymer electrolyte. In some embodiments, an electrolyte comprises an organic electrolyte. In some embodiments, an electrolyte comprises a lithium salt. In some embodiments, an electrolyte comprises an ionic liquid. In some embodiments, an electrolyte comprises a deep eutectic solvent. The electrolyte can be used in the manufacture of a lithium metal electrode. The electrolyte can be used in a rechargeable energy source system.

In some embodiments, an electrolyte is non-flammable or fire-resistant. In some embodiments, an electrolyte is substantially non-volatile at room temperature and pressure. In some embodiments, an electrolyte is non-flammable at room temperature and pressure. In some embodiments, an electrolyte is self-extinguishing. In some embodiments, an electrolyte comprises additives, e.g., nitrogen, sulfur, phosphorus, or silicon compounds.

In some embodiments, an electrolyte comprises a decomposition potential of at least 2, 3, 4, 5, or 6 V. In some embodiments, an electrolyte comprises a decomposition potential of at most 2, 3, 4, 5, or 6 V. In some embodiments, an electrolyte comprises a dielectric constant of at least 2, 5, 10, 20, 30, 40, 50, 60, 70, or 80. In some embodiments, an electrolyte comprises a dielectric constant of at most 3, 5, 10, 20, 30, 40, 50, 60, 70, 80, or 90. An electrolyte can comprise various viscosities. Polymeric or polymer solution electrolytes can comprise a large viscosity, as the viscosity can scale exponentially with the molecular weight of the polymer above a critical molecular weight (e.g., entanglement molecular weight). In some embodiments, an electrolyte comprises a viscosity of at least 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 kPa·s. In some embodiments, an electrolyte comprises a viscosity of at most 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 kPa·s.

Various organic electrolytes can be used. In some embodiments, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some embodiments, an electrolyte can comprise an organic carbonate compound, an ester compound, an ether compound, a ketone compound, an alcohol compound, an aprotic bipolar solvent, or a combination thereof. The carbonate compound may be an open chain carbonate compound, a cyclic carbonate compound, a fluorocarbonate derivative thereof, or a combination thereof.

In some embodiments, the chain carbonate compound can be diethyl carbonate (“DEC”), dimethyl carbonate, (“DMC”), dipropyl carbonate (“DPC”), methylpropyl carbonate (“MPC”), ethylpropylcarbonate (“EPC”), methylethyl carbonate (“MEC”), and a combination thereof. In some embodiments, the cyclic carbonate compound can be ethylene carbonate (“EC”), propylenecarbonate (“PC”), butylene carbonate (“BC”), fluoroethylene carbonate (“FEC”), vinylethylene carbonate (“VEC”), and a combination thereof. In some embodiments, the fluorocarbonate compound can be fluoroethylene carbonate (“FEC”), 4,5-difluoroethylene carbonate, 4,4-difluoroethylene carbonate, 4,4,5-trifluoroethylene carbonate, 4,4,5,5-tetrafluoroethylene carbonate, 4-fluoro-5-methylethylene carbonate, 4-fluoro-4-methylethylene carbonate, 4,5-difluoro-4-methylethylene carbonate, 4,4,5-trifluoro-5-methylethylene carbonate, trifluoromethylethylene carbonate, and a combination thereof. In some embodiments, the carbonate compound may include a combination of cyclic carbonate and chain carbonate, in consideration of dielectric constant and viscosity of the electrolyte. In some embodiments, the carbonate compound may be a mixture of such chain carbonate and/or cyclic carbonate compounds as described above with a fluorocarbonate compound. In some embodiments, the fluorocarbonate compound may increase solubility of a lithium salt to improve ionic conductivity of the electrolyte, and may facilitate formation of the thin film on the negative electrode. In some embodiments, the ester compound is methyl acetate, ethyl acetate, n-propyl acetate, dimethyl acetate, methyl propionate (“MP”), ethyl propionate, γ-butyrolactone, decanolide, valerolactone, mevalonolactone, caprolactone, and methyl formate. In some embodiments, the ether compound is dibutyl ether, tetraglyme, diglyme, 1,2-dimethoxyethane, 1,2-diethoxyethane, ethoxymethoxyethane, 2-methyltetrahydrofuran, and tetrahydrofuran. An example of the ketone compound is cyclohexanone. In some embodiments, the alcohol compound can be ethyl alcohol or isopropyl alcohol. In some embodiments, the aprotic solvent can be a nitrile (such as R—CN, wherein R is a C2-C20 linear, branched, or cyclic hydrocarbon-based moiety that may include a double-bond, an aromatic ring or an ether bond), amides (such as formamide and dimethylformamide), dioxolanes (such as 1,2-dioxolane and 1,3-dioxolane), methylsulfoxide, sulfolanes (such as sulfolane and methylsulfolane), 1,3-dimethyl-2-imidazolidinone, N-methyl-2-pyrrolidinone, nitromethane, trimethyl phosphate, triethyl phosphate, trioctyl phosphate, and triester phosphate. In some embodiments, an electrolyte can comprise an aromatic hydrocarbon organic solvent in a carbonate solvent. In some embodiments, an aromatic hydrocarbon organic solvent can be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, 3,5-difluorotoluene, 2,3,4-trifluorotoluene, 2,3,5-trifluorotoluene, 2,3,6-trifluorotoluene, 3,4,5-trifluorotoluene, 2,4,5-trifluorotoluene, 2,4,6-trifluorotoluene, 2-chlorotoluene, 3-chlorotoluene, 4-chlorotoluene, 2,3-dichlorotoluene, 2,4-dichlorotoluene, 2,5-dichlorotoluene, 2,6-dichlorotoluene, 2,3,4-trichlorotoluene, 2,3,5-trichlorotoluene, 2,3,6-trichlorotoluene, 3,4,5-trichlorotoluene, 2,4,5-trichlorotoluene, 2,4,6-trichlorotoluene, 2-iodotoluene, 3-iodotoluene, 4-iodotoluene, 2,3-diiodotoluene, 2,4-diiodotoluene, 2,5-diiodotoluene, 2,6-diiodotoluene, 3,4-diiodotoluene, 3,5-diiodotoluene, 2,3,4-triiodotoluene, 2,3,5-triiodotoluene, 2,3,6-triiodotoluene, 3,4,5-triiodotoluene, 2,4,5-triiodotoluene, 2,4,6-triiodotoluene, o-xylene, m-xylene, p-xylene, and combinations thereof.

Various polymeric electrolytes can be used. A polymer electrolyte can comprise poly(ethylene oxide), poly(vinyl alcohol), poly(methyl methacrylate), poly(caprolactone), poly(chitosan), poly(vinyl pyrrolidone), poly(vinyl chloride), poly(vinyl fluoride), poly(imide), or any combination thereof, which can inherently conduct lithium ions or be doped with one or more lithium salts to make the polymer be lithium conductive.

Various ionic liquids can be used, e.g., any one of the ionic liquids listed on the Ionic Liquids Database (ILThermo) of the National Institute of Standards and Technology.

Various lithium salts can be used. A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof. In some embodiments, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), and 1-ethyl-3-methylimidazolium-bis(trifluoromethylsulfonyl)imide (EMI-TFSI). In some embodiments, the catholyte 290 comprises ionic liquid-forming salts dissolved in 1,3-dioxolane (DOL), 1,2 dimethoxyethane (DME), or tetraethylene glycol dimethyl ether (TEGDME). In some embodiments, an electrolyte can comprise Li₂SO₄, Li₂CO₃, LiPF₆, LiBF₄, LiBH₄, LiBO, LiDFOB, LiClO₄, LiTFSI, and combinations thereof. In some embodiments, an electrolyte can comprise LiPF₆, LiBF₄, LiBH₄, LiBO, LiDFOB, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBioCl₁₀, CH₃SO₃Li, C₄F₃SO₃Li, (CF₃SO₂)₂NLi, LiN(CₓF₂ₓ₊₁SO₂)(CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, and any combination thereof. In some embodiments, a concentration of the lithium salt may be in a range of about 0.1 molar (“M”) to about 2.0 M. In some embodiments, a concentration of the lithium salt is at least 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M. In some embodiments, a concentration of the lithium salt is at most 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M.

The electrolyte can comprise a lithium conductive polymer. The lithium conductive polymer can be a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, multiblock copolymer, and grafted copolymer. In some embodiments, the block copolymer can comprise PDMS-PEG (e.g., poly(poly dimethylsiloxane methacrylate)-b-poly(poly(ethylene glycol) methacrylate)). In some embodiments, the block copolymer can comprise POEM-b-PLMA, POEM-P (PDMSMA), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof.

In some embodiments, an electrolyte may be a high conductivity electrolyte with a lithium transference number >0.3, a low flammability, and weakly solvating ability to minimize the charge transfer resistance. In some embodiments, fluorinated compounds tend to make an inorganic rich SEI layer that promotes higher coulombic efficiencies.

### Separator

A separator can be provided between a negative electrode and a positive electrode. The separator can be in contact with the layer of lithium metal. The separator can be in contact with the positive electrode.

The separator can comprise a polymer or a ceramic membrane. The separator can be wetted with an electrolyte. The separator can comprise a surface that is substantially non-reactive with lithium metal.

The separator can comprise a polypropylene surface. The separator can comprise a single layer or multiple layers. The separator can comprise glass fiber, polyester, Teflon, polyethylene, polypropylene, polyvinylidene fluoride (“PVDF”), polytetrafluoroethylene (“PTFE”), or a combination thereof. The separator can comprise at least three layers. The at least three layers can comprise polypropylene, polyethylene, and polypropylene, in order.

The separator can have a porosity of at least 10, 20, 30, 40, 50, 60, 70, or 80 percent. The separator can have a porosity of at most 10, 20, 30, 40, 50, 60, 70, or 80 percent. The separator can have a porosity of at least 55%. The separator can have a porosity of at most 55%. The separator can have a porosity of about 55%.

The separator can be at least 5, 10, 15, 20, 25, 30, 35, 40, 45, or 50 μm thick. The separator can be at most 5, 10, 15, 20, 25, 30, 35, 40, 45, or 50 μm thick. The separator can be 5 to 50 μm thick.

The separator can selectively conduct lithium ions between the negative electrode and the positive electrode. The separator can substantially prevent or inhibit the passage of organic solvents, anions of lithium salts, water, or a contaminant from being transferred between the negative electrode and the positive electrode. The separator can hydrophobic polymers. The separator can comprise lithium-ion conductive channels.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: a Rechargeable Energy Source System with a Lithium-Free Positive Electrode

This example provides a prophetic example of a rechargeable energy source system with a de-lithiated positive electrode.

A rechargeable energy source system comprising a negative electrode and a de-lithiated positive electrode is manufactured. The negative electrode comprises a layer of lithium metal, and the positive electrode comprises one of the positive electrode materials listed in Table 1 (e.g., a VₓO_{y} material). The potential difference, excluding overpotentials, between the negative electrode and the positive electrode is at least 2.5 V, or any one of the values provided in Table 1. The lithium content and the amount of positive electrode material is balanced, such that, at a discharged state of the rechargeable energy source system, the negative electrode comprises less than 10%, 5%, or 1% of total lithium in the rechargeable energy source system. At the same time, in a charged state of the rechargeable energy source system, the positive electrode comprises less than 10%, 5%, or 1% of total lithium in the rechargeable energy source system while being structurally stable. The positive electrode is structurally stable in that its difference in volume between the discharged state and the charged state of the rechargeable energy source system is less than or equal to 10%, 5%, or 3%. Thus, charge cycling the rechargeable energy source system creates negligent or acceptable amount of stress on its components, and the positive electrode material does not develop cracks that lead to loss of active material. The charge cycling experiments are conducted at various conditions which the rechargeable energy source system is expected to operate, e.g., for handheld electronics (e.g., phones), electric vehicles, energy storage from windmills, etc. The energy density of the rechargeable energy source system is at least 350 Wh/kg with an appropriate choice of the positive electrode material from Table 1. The rechargeable energy source system utilizes for redox reactions at least 90% of total lithium in the rechargeable energy source system while charging and while discharging. The potential difference is at least 2.5 Volts between a negative electrode and a positive electrode of the rechargeable energy source system. Discharging the rechargeable energy source system expands a volume of the positive electrode by less than 15%.

### Example 2: Synthesis of VₓO_{y}F_{z}

This example provides prophetic methods of making VₓO_{y}F_{z}. Where Mx-2y-z=0, and M is the oxidation state of V ranging from +3 to +5. For example, for V₆O₅F₁₉, x=6, y=5, z=19, and M=+4.83.

VF₄ and V₂O₅ precursors are mixed in stoichiometric amounts, sometimes with a slight (<10%) excess VF₄ to accommodate any loss due to gas evolution. The mixture is put inside an alumina crucible, or sealed inside a quartz crucible, and fired at temps ranging from 350-550° C. for times ranging from 2-12 hrs. Preferred is 400° C. for about 6 hours. The synthesis is carried out in an inert Ar atmosphere. After synthesis the powders are carbon coated using carbothermal reduction, and then mixed with a suitable binder (i.e. PVDF) and used as electrodes after being cast on current collectors (i.e. aluminum) and calendared to appropriate thicknesses.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

1. (canceled)

2. An electrochemical system comprising:
(a) a negative electrode comprising a layer of lithium metal having a density of at least about 0.4 g/cm³; and
(b) a positive electrode that is substantially free of lithium when the rechargeable energy source system is in a charged state;
wherein the positive electrode has a capacity of at least 250 mAh/g, and wherein the positive electrode is configured to exhibit a volumetric change of less than about 15% between a discharged state and a charged state.

3. The electrochemical system of claim 1, wherein the positive electrode is configured to maintain the volumetric change over at least 100 charge/discharge cycles of the electrochemical system.

4. The electrochemical system of claim 3, wherein the positive electrode comprises vanadium atoms.

5. The electrochemical system of claim 4, wherein the positive electrode comprises VₓO_{y}.

6. The electrochemical system of claim 5, wherein the positive electrode comprises VₓO_{y}F_{z}.

7. The electrochemical system of claim 4, wherein the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈.

8. (canceled)

9. The electrochemical system of claim 4, wherein the rechargeable energy source system comprises lithium in excess, the lithium in excess comprising less than about 10% of a net amount of lithium transferred between the negative electrode and the positive electrode during discharging or charging of the rechargeable energy source system.

10. The electrochemical system of claim 2, wherein the positive electrode is configured to exhibit a volumetric change of less than about 10% over at least 100 charge/discharge cycles of the rechargeable energy source system.

11. The electrochemical system of claim 2, wherein an energy capacity loss of the rechargeable energy source system is less than about 1% over at least 100 charge/discharge cycles.

12. The electrochemical system of claim 11, wherein an energy capacity loss of the rechargeable energy source system is less than about 1% over at least 300 charge/discharge cycles.

13. The electrochemical system of claim 2, wherein a N/P ratio is less than 0.1 when the rechargeable energy source system is fully discharged.

14. The electrochemical system of claim 13, wherein a N/P ratio is about zero when the rechargeable energy source system is fully discharged.

15. The electrochemical system of claim 2, wherein the lithium from the negative electrode is added into the positive electrode via an intercalation mechanism or a conversion mechanism.

16. The electrochemical system of claim 2, wherein the layer of lithium metal comprises a thickness of less than 100 μm.

17. The electrochemical system of claim 2, wherein the positive electrode comprises less than 10% lithium by mass of total lithium in the electrochemical system at a discharged state.

18.-25. (canceled)

26. The electrochemical system of claim 16, wherein the layer of lithium metal comprises a thickness of less than 50 μm.

27. The electrochemical system of claim 17, wherein the positive electrode comprises less than 5% lithium by mass of total lithium in the electrochemical system at a discharged state.

28. The electrochemical system of claim 2, wherein the positive electrode is configured to exhibit a volumetric change of less than about 3% between a discharged state and a charged state.

29. The electrochemical system of claim 11, wherein an energy capacity loss of the rechargeable energy source system is less than about 1% over at least 500 charge/discharge cycles.
